(19) United States
(12) Patent Application Publication
(10) Pub. No.: US 2003/0004887 A1
(43) Pub. Date: Jan. 2, 2003

(54) Verification and registration of items containing digitally embedded information

(76) Inventor: Matthew S. Roszak, Laguna Hills, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 09/894,343

(22) Filed: Jun. 28, 2001

(51) Int. Cl. G06F 17/60

(52) U.S. Cl. 705/57

(57) ABSTRACT

The present invention provides system and method for verifying, registering, cataloging, interacting, and trading various items with digitally embedded information over the Internet. The system and method are implemented by software running on the client side and the service provider side. Through the service provider's web site, a user can use the digitally embedded item to perform various available options.

The digitally embedded item can be smart cards, collectible dolls, toys, automobiles, et cetera. The system and method disclosed herein may be implemented using any such digitally embedded items.

In accordance with the invention, the authenticity of the item can be verified using digital data embedded in the item. Additionally, the user can add the item to the service provider's master catalog. The users can trade the items on-line and track ownership history as well.

In the case where the digitally embedded item is a smart card with embedded memory, the card can be used to play on-line, multi-player games.

### BACKGROUND OF THE INVENTION

1. Field of the Invention

This invention relates generally to verification and registration of items containing digitally embedded information. More particularly, the invention relates to system and method for validating, registering, cataloging, trading, and interacting with digitally embedded items such as digitally embedded collectible trading cards over the Internet.

2. Description of the Related Art

Collectible trading cards are well-known and have been popular for many years, especially in the field of sports. Typically, the trading card includes a photograph of a sports player on one side and the player's performance statistics on the other side. Such cards are sold, collected, and traded by collectors and vendors.

Traditionally, the trading cards are manufactured out of paper. Due to the ease with which a paper product can be reproduced, the traditional trading card industry has faced forgery problems for years. Therefore, the traders and the buyers have had to risk that their newly acquired cards were not authentic.

Additionally, the cards are typically sold or traded in a face-to-face interaction between a seller and a buyer. The necessity of a face-to-face interaction between a seller and a buyer limited the potential market to which a seller could offer the cards for sale and from which a buyer can search for a particular card he/she desires. The forum in which most of the buying, selling, and trading activities took place were the vendor shops, trade shows, hobby clubs, and among friends and acquaintances.

With the widespread popularity of the Internet and the accompanying technology, some attempts have been made to incorporate the newly available technology into the trading card industry. Such attempts include recording player's performance statistics on a bar code or substituting either a floppy disk or an optical disk as the trading card. The problems of forgery were not addressed. Additionally, the substitution of either a floppy or the optical disks was not desirable since the traditional look and feel of the trading cards were missing.

### SUMMARY OF THE INVENTION

The preferred embodiments of the present invention provide systems and methods for verifying, registering, cataloging, interacting, and trading various items with digitally embedded information over the Internet. These embodiments enable the verification of a collectible trading card. As in the case of any collectible item, a factor that often affects the value of the trading card is the ownership history associated with the card. A feature of this invention is providing a system and method to track the identity of previous owners of a collectible card. Being able to track the ownership history of the collectible card substantially enhances the trading and the ownership experience.

The system and method are implemented by software running on the client side and the service provider side. Through the service provider's web site, a user can perform various available options.

While the various examples are described using digitally embedded cards e.g., smart cards, it is contemplated that the invention be implemented for any item such as collectible dolls, toys, automobiles, et cetera, containing digitally embedded information. Accordingly, it is to be understood that the invention is not to be limited by the specific illustrated examples, but only by the scope of the claims. It is contemplated that the system and method disclosed herein may be implemented using any digitally embedded items.

As noted above, one feature of the preferred embodiment offers a user the option to verify the authenticity of the smart collectible trading cards (SCTC). Using the digital authenticity data comprising, for example, digital serial number and digital key located within the memory device such as an EPROM on the SCTC, the authenticity of the SCTC is verified. The user has an option of adding the SCTC to the service provider's master catalog. Registering the SCTC, places the SCTC in an active state within the service providers' master catalog. Placing the SCTC in an active state can enable various functionalities. For example, active status can enable on-line trading of the SCTC. On-line trading option reaches interested parties around the world using the Internet. Any interested party can verify authenticity before actual transactions occur. After the transaction, the acquiring party can add the acquired SCTC to his/her own catalog, automatically eliminating it from the previous owner's catalog.

Another feature of a preferred embodiment of the invention is to provide the user with ability to interact with other users using the SCTC. The user can engage in on-line multiplayer games, fantasy sports and other forms of on-line activities. The SCTC can be used in an offline format at any time.

Still another advantage of the preferred embodiment of the invention is that the users with validated, registered SCTC's can catalog and manage their SCTCs, using any criteria, in an on-line environment. Cataloging and managing SCTCs can help maintain an organized on-line environment and can facilitate utilizing other aspects of the service provider's web site. Trading SCTC using the on-line cataloging system allows interested parties to view the user's complete collection, if the user so desires. The cataloging and managing feature enables a user to customize the layout his/her SCTC on-line.

Additionally, the user can advantageously catalog and manage the SCTC in a way that best suits his/her viewing preference. The user's viewing preference may be altered depending on whether he/she is viewing the SCTCs for trading purposes or on-line gaming purposes. An additional option available to users includes maintaining SCTC ownership history. This ownership history feature facilitates valuation of any particular SCTC since the ownership history, as well as rarity or demand, would dictate the value of the SCTC. Such tracking also helps cut down on illegal duplication.

Other options available to the user include trading and playing on-line games. With all of the SCTCs from different users stored in the database, users can choose to take part in a massive trading program that also includes buying and selling of the SCTCs.

The user can also take part in various on-line multi-player card games using the SCTCs. The games can consist of unlimited number of players and can have full text communication along with fall graphics. The rules of the game as well as the difficulty level of the game are modifiable.

This invention eliminates illegal duplication of collectible cards by merging smart card technology into collectible cards. Even if a SCTC was duplicated with an embedded EPROM, the SCTC could not be verified with a central repository at the service provider's database because the verification of the authenticity encompasses comparing the data stored at the central repository to which the fraudulent manufacturer does not have access. Furthermore, if the SCTC was duplicated with a counterfeit digital ID the member holding the genuine ID could simply re-insert their SCTC to regain possession of that ID. Moreover, any such persistent problem could be addressed by deleting the problematic ID and replacing the breached SCTC.

### BRIEF DESCRIPTION OF THE DRAWINGS

These and other features will now be described with reference to the drawings summarized below. These drawings and the associated description are provided to illustrate a preferred embodiment of the invention, and not to limit the scope of the invention. The like reference numbers represent corresponding components throughout the drawings reference numbers are re-used to indicate correspondence between referenced elements. In addition, the first digit of each reference number indicates the figure in which the element first appears.

FIG. 1 illustrates an example implementation of the overall system 100 according to one embodiment of the invention.

FIG. 1A illustrates an example implementation of the smart trading card 101A.

FIG. 1B illustrates an example implementation of the card reader 101.

FIG. 1C illustrates an example implementation of the server 106.

FIG. 2 illustrates one example implementation of user options 210.

FIG. 3 is a flow diagram illustrating an example implementation of the user option to verify the authenticity of the smart trading card 101A.

FIG. 4 is a block diagram illustrating the various software modules involved in the user option to verify the authenticity of the smart trading card 101A.

FIG. 5 is a flow diagram illustrating the user option 500 depicted in FIG. 2.

FIG. 5A illustrates an example user interface screen to facilitate entering of the membership data.

FIG. 6 is a block diagram illustrating various modules of user option 600.

### DETAILED DESCRIPTION OF THE EMBODIMENTS

In the following description, reference is made to the accompanying drawings, which form a part hereof and which show, by way of illustration, specific embodiments or processes in which the invention may be practiced. In some instances, numerous specific details are set forth in order to provide a thorough understanding of the invention. The invention, however, may be practiced without the specific details or with certain alternative equivalent devices or components and methods to those described herein. In other instances, well-known methods and devices or components have not been described in detail so as not to unnecessarily obscure aspects of the invention.

As indicated previously, while the various examples are described using smart cards, it is contemplated that the system and method described may be implemented for any items containing digitally embedded data.

Collectible cards are ubiquitous and their popularity continues to grow even in today's digital society. A way of introducing the collectible card into the digital world is to integrate smart card technology. A memory component such as an erasable programmable read only memory (EPROM) chip embedded in the collectible card allows the collector to validate, catalog and interact on-line with their collectible card via a computer linked to reader capable of reading the data stored on the memory component of the card.

Using the Internet, the preferred embodiment of the invention enables the collectible card industry to achieve new levels of interactivity. The traditional collectible card offers very limited interaction between it and its owner. Additionally, most card games require physical cards in order to play games, at a common physical location in a face-to-face interaction. On the other hand, using the trading cards of the preferred embodiment with embedded memory component such as an EPROM, a player can play on-line games with players located at another location. The collector is now able to play the same strategy or fantasy sports collectible card games with others over the Internet with remotely located players.

The ability to identify the cards on-line enables the collector to inventory, manage and arrange the cards using criteria that best accommodates the collector. Establishing both physical and virtual card catalogs enables the collector to participate in on-line and/or offline trading and game playing.

The present invention describes the merging of smart card technology with the collectible trading card. Together, the smart card and collectible trading card create a new way of interacting with the communication mediums such as the Internet. As described elsewhere herein, various refinements and substitutions of the various embodiments are possible based on principles and teachings herein.

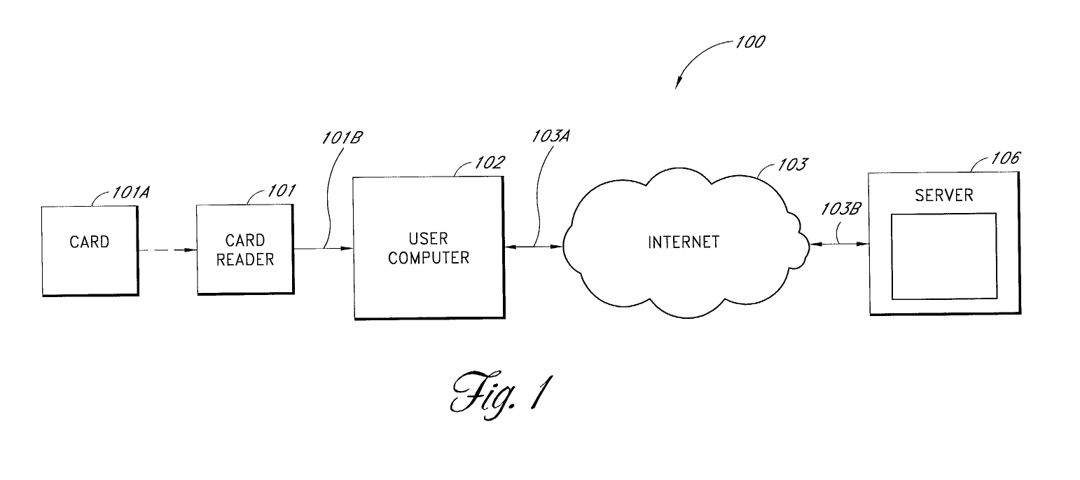

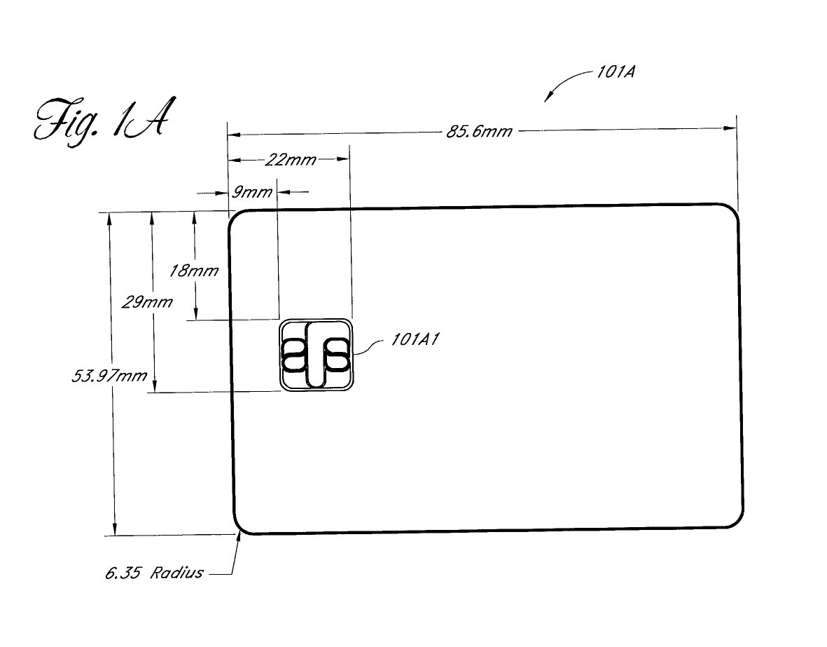

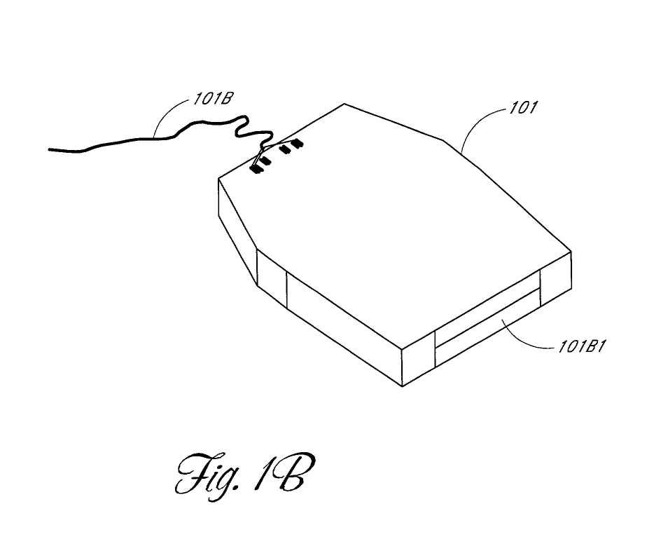

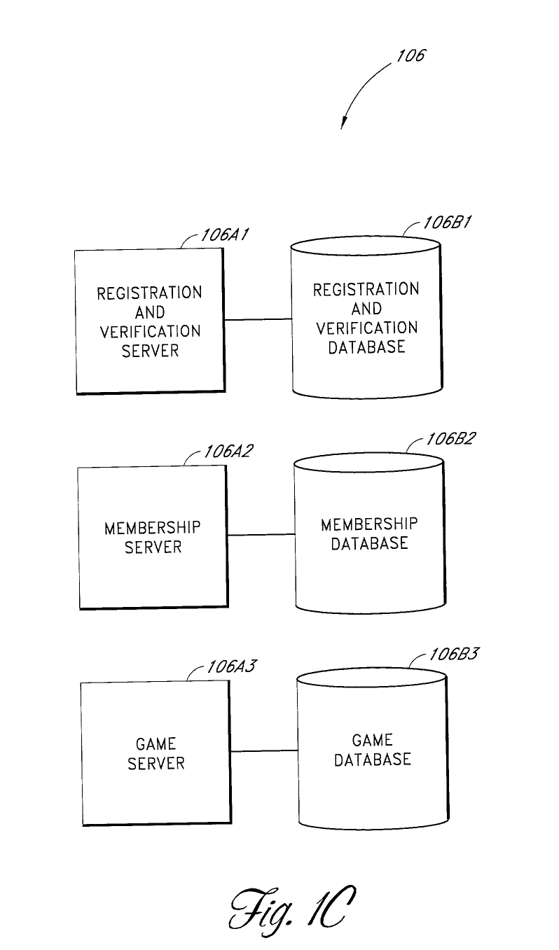

FIG. 1 illustrates an example implementation of the overall system 101A according to one embodiment of the invention. The system 100 comprises a smart trading card 101A, a card reader 101, a card reader connection 101B, a user computer 102, a connection 103A, the Internet 103, a connection 103B, and a server 106. The card reader 101 is connected to the user computer 102 by the connection 101B. The user computer 102 and the server 106 are connected to the Internet 103 by the connection 103A and the connection 103B, respectively.

The smart trading card 100 further comprises a memory component such as an EPROM. The memory component stores digital data. The information stored in the memory component can be used for various purposes including validating and registering the smart trading card 101A on-line with the server 106 via the Internet 103.

The user computer 102 further comprises a CPU, a hard drive, a monitor, a compact disk read-only memory (CD ROM) drive, a keyboard, a mouse, and the connection 103A.

FIG. 1A illustrates an example implementation of the smart trading card 101A. Smart cards are typically about the size of a credit card and contain a small amount of memory and sometimes a processor. The original premise of smart cards was for them to be used in financial applications similar to a credit card or bank ATM card. However, smart cards have gained in popularity for other applications. In Europe, they are used for varying applications including public transportation, identification and food payment applications for university students, and parking tolls, for example.

The example smart trading card 101A illustrated in FIG. 1A is 85.6 mm in length and 53.97 mm in width. The front edge of the memory component 101A1, in this example an EPROM, sits 9 mm back from the end inserted into the card reader 101 and 22 mm from the back edge of the EPROM. The right edge of the EPROM sits 18 mm from the right side of the card when it is face up with EPROM exposed and 29 mm from the left edge of the EPROM. The corners of the EPROM card are a 6.35 radius. The EPROM 101A1 can have varying storage capacity. For example, the memory capacity of the EPROM 101A1 can range from 16 bits to 1 megabyte.

Alternatively, the card containing the digital data may be implemented using a global system for mobile communications (GSM) card, similar to those used with the cellular telephones. Moreover, the item containing the digital data may not be in the form of a card at all. As indicated previously, the item containing the digital data may be any item containing the digitally embedded data such as a collectible doll with digitally embedded data.

The smart trading card 101A can also include graphical displays on the card itself such as original art, much like a traditional collectible trading card thereby increasing the card value beyond just the technological makeup of the smart card. The card is used in conjunction with the card reader 101. Moreover, special edition cards such as seasonal cards and limited editions cards can provide further variety to the artwork included on the cards 101A.

FIG. 1B illustrates an example implementation of the card reader 101. The example card reader 101 illustrated in FIG. 1B includes a slot 101B1 on the front into which the smart card 101A is inserted and a card reader connection 101B to attach the card reader 101 to the user computer 102. The card reader 101 can be connected to the user computer by various methods. FIG. 1B illustrates a connection method 101B using a cable. Using a cable, the card reader 101 can be connected to, for example, a serial or a universal serial bus (USB) port of the user computer 102. The card reader can connect to the user's computer by other connection methods as well. For example, the card reader 101 may be installed internally to the user computer 102. The card reader 101 can also be integrated into the keyboard of the user computer 102.

Alternatively, the reader of the digital data such as those stored in the memory device of the item may not be connected to the user's computer at all. For example, the reader of the digital data embedded in a collectible doll, for example, may be a wireless radio proximity reader.

To begin tasks associated with the smart trading card 101A, the user inserts the card 101A into the slot 101B1 on the card reader 101.

Referring to FIG. 1, the Internet 103 is used as the communication medium via which the information between the user computer 102 and the server 106 is exchanged. Although the Internet 103 is shown as the communication medium between the user computer 102 and the server in FIG. 1, any form of global networking to exchange information may be used. Additionally, the user computer 102 and the server 106 can connect to the Internet 103 by any connection method. For example, the connection 103A and 103B can be a dial-up modem connection or a digital subscriber line (DSL) connection.

FIG. 1C illustrates an example implementation of the server 106. The server 106 can comprise one or more servers. For example, the server 106 can comprise servers 106A1, 106A2, 106A3. Likewise, the server 106 can comprise one or more databases including databases 106B1, 106B2, 106B3, for example. A single server and a single database can be designated to handle all tasks. On the other hand, tasks to be handled by the server 106 can be distributed among several servers and several databases. Data to and from the user may be divided up and distributed among various servers and databases. Likewise, data storage may be distributed among one or more databases. Similarly, the server 106A1 may be designated as a registration and verification server, the server 106A2 as a membership server, and the server 106A3 as a game server. For example, data related to registration and verification may be stored on the registration and verification database 106B1 while the data related to membership may be stored on the membership database 106B2, and the game-related data on the game database 106B3.

The registration and verification server and the registration and verification database can be dedicated to performing tasks to facilitate maintaining the security of the smart trading cards. The registration and verification database, likewise, can be dedicated to store the master catalog of all the smart trading cards manufactured. Similarly, the membership server and membership database can be dedicated to manage all information pertaining to memberships.

In like manner, the game server and the game database can be dedicated to manage all information pertaining to the game aspects of the cards and decks. As a user's physical card collection grows he/she will be able to add the smart trading cards to his/her on-line catalog and organize them into decks that best suit their needs. The tasks and information related to games, management, and cataloging of the smart trading cards can be handled and stored by the game server and the game database, respectively.

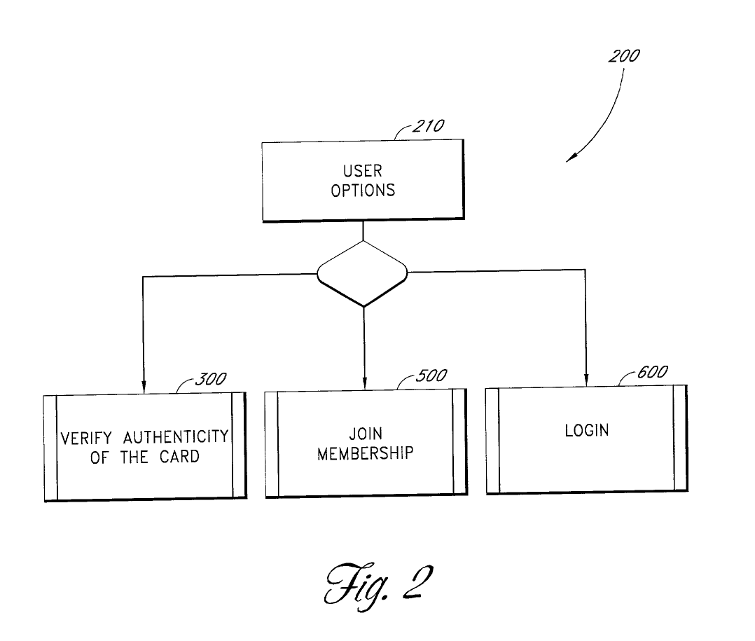

FIG. 2 illustrates one example implementation of various user options 210. User options are options available to the user upon accessing the server 106. According to the example implementation of the user options depicted in FIG. 2, upon accessing the server 106, the user has the option 300 to verify the authenticity of the smart trading card 101A, the option 500 to join membership, and the option 600 to login as a member. Each of these options is discussed in detail below.

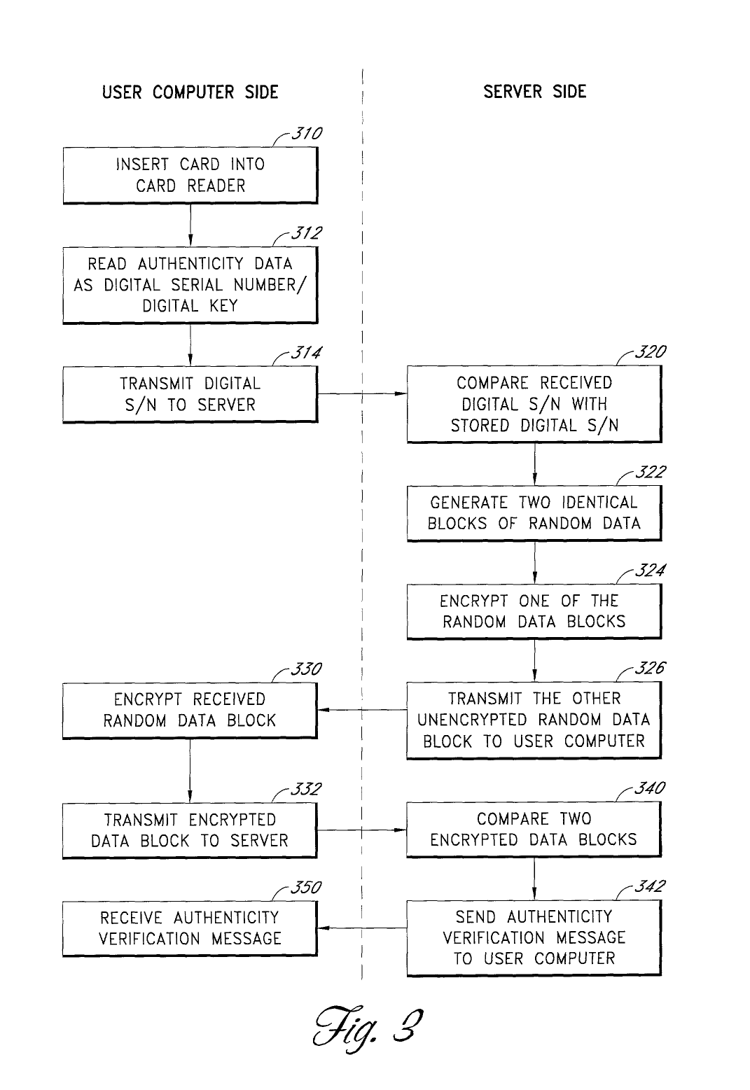

FIG. 3 illustrates an example implementation of the user option 300 to verify the authenticity of the smart trading card 101A. The user option 300 to verify the authenticity of the card involves tasks being performed by both the user computer 102 and the server 106.

Referring to FIG. 3, at a step 310 the user inserts the smart trading card 101A into the slot 101B1 of the card reader 101. At a step 312, authentication data stored on the memory component 101A1 of the smart card 101A is read by the card reader 101 under the control of the user computer 102. The authentication data comprises various data. For example, the authentication data may comprise a digital serial number and a digital key, as well as any other type of data. In the example illustrated in FIG. 3, the authentication data comprises a digital serial number and a digital key which are read from the smart trading card as a user digital serial number (DSN_{User}) and a user digital key (DK_{User}). The authentication data uniquely identifies a particular smart trading card and can be used to verify its authenticity. At a step 314, the user computer 102 transmits the authentication data, in this example, the DSN_{User}, to the server 106 via the Internet 103.

At a step 320, the server 106 compares the authentication data DSN_{User} received from the user computer 102 against validity data, in this case, the digital serial numbers (DSN_{Server}) stored in the database 106B. The database 106B includes a list of all valid authentication data including valid digital serial numbers, DSN_{Server}, and all valid digital keys, DK_{Server}, in a master catalog. Such validity data is maintained to authenticate the smart trading cards. If the attempt to verify the SCTC fails, the user receives a message indicating failed authentication attempt and is offered the option to retry or cancel the verification process.

At a step 322, the server 106 generates two identical blocks of random data, RD₁ and RD₂, after comparing the DSN_{User} against a list of DSN_{Server}. At a step 324, the server 106 encrypts one of the random block of data, RD₁, using the digital key, DK_{Server}, associated with a particular DSN_{Server}. At a step 326, the server 106 transmits the unencrypted random data block, RD₂, to the user computer 102.

At a step 330, the user computer 102 encrypts the received random data block RD₂ using the digital key DK_{User} read from the smart trading card 101A. At a step 332, the user computer 102 transmits the encrypted RD₂ to the server.

At a step 340, the server 106 compares the encrypted random data blocks RD₁ and RD₂. At a step 342, the server 106 transmits a message to the user computer 102 confirming the authenticity of the smart trading card 101A if the comparison of RD₁ and RD₂ is successful. If the comparison of RD₁ and RD₂ is not successful, a message invalidating the authenticity is sent to the user computer.

At a step 350, the user computer 102 receives the appropriate authenticity verification message.

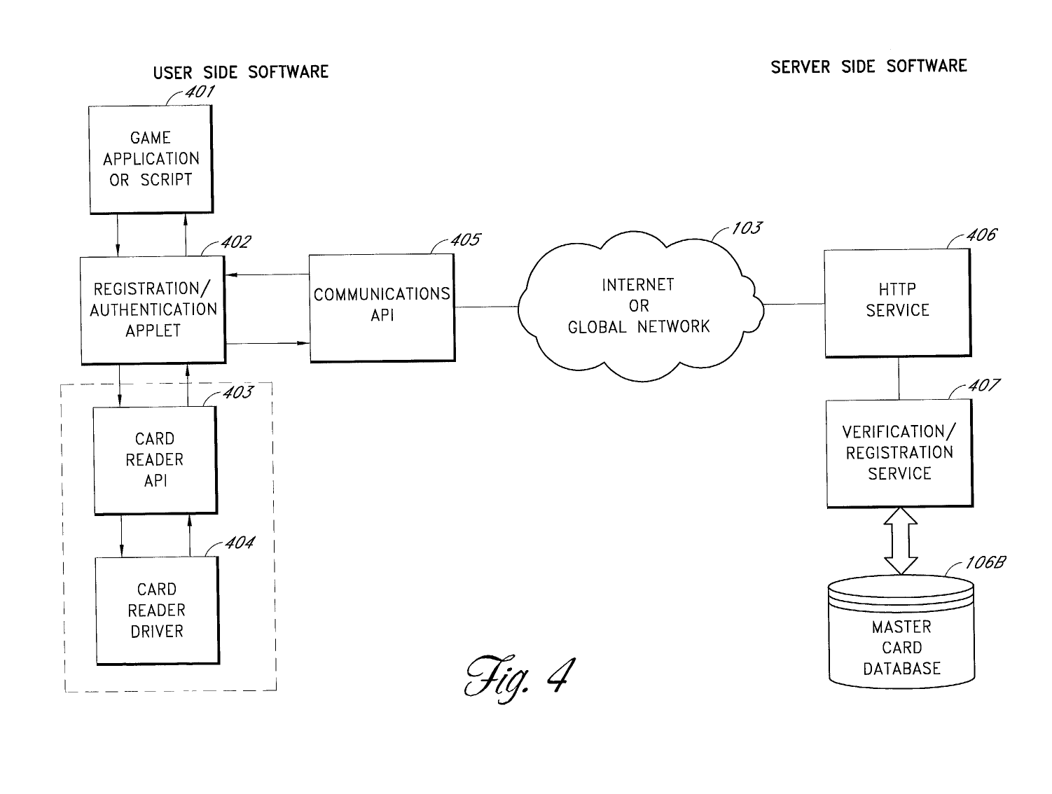

FIG. 4 illustrates various software modules involved in the user option 300 to verify the authenticity of the smart trading card 101A. The term “module,” as used herein, means, but is not limited to, a software or hardware component, such as a field programmable gate arrays (FPGA) or application-specific integrated circuit (ASIC), which performs certain tasks. A module may advantageously be configured to reside on the addressable storage medium and configured to execute on one or more processors. Thus, a module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and modules may be combined into fewer components and modules or further separated into additional components and modules. Additionally, the components and modules may advantageously be implemented to execute on one or more computers.

As indicated previously, the software modules involved in the user option 300 to verify the authenticity of the smart trading card 101A comprise modules on both the user side and the server side.

The modules on the user side comprise a game application script module 401, a verification/registration applet module 402, a card reader application program interface (API) module 403, a card reader driver module 404, and a communications API module 405.

The game application script module 401 handles the user interface (UI) of an on-line game. This module may be implemented by embedding scripts within the web pages of the server 106. Script is a program consisting of a set of instructions to an application program. On the World Wide Web, scripts are commonly used to customize or add interactivity to web pages. This module communicates with the Verification/Registration Applet 402 installed on the user computer 102.

The verification/registration applet module 402 includes custom protocols and formats for both data and communication messages between the card reader 101, the game application script module 401, and the user option 300 to verify the authenticity of the card. An applet is a program that can be downloaded over the Internet and executed on the recipient's machine. Applets are typically used to customize or add interactive elements to a web page.

The card reader API module 403 is an off-the-shelf software module. This software module can be based on the industry standard specification such as Personal Computer/Smart Card (PC/SC) or a third party's custom specification. In the event the industry standard PC/SC specification is used, the card reader driver component may be supplied by the manufacturer of the card reader. If a third party custom specification is used, the drivers are inclusive of the API software supplied by the third party manufacturer. Any of these methods may be used to distribute equipment and software to users.

The card reader driver module 404 is usually supplied by the manufacturer of the card reader 101. This software may be included as part of the card Reader API described above. This module communicates directly with the card reader 101 hardware.

The communications API module 405 is supplied by the operating system (O/S) of the user computer 102. This module is responsible for establishing secure communication socket over the network 103 to the server 106.

The modules on the server side comprise a hypertext transfer protocol (HTTP) service module 406 and a verification/registration service module 407.

The HTTP service module 406 is an off-the-shelf web server software module. The HTTP protocol is used to carry requests from a web browser to a web server and to transport pages from web server back to the requesting browser. The module 406 thereby provides the proper connection point on the Internet to perform the Verification/Registration services.

The verification/registration service module 407 provides the proper protocols and data formats used in the secure communications with the verification/registration applet module 402. The verification/registration service module 407 takes a request from the user applet module 402 and communicates with the database 106B to produce encoded communications with the user applet module 402. Communication with the database 106B is accomplished with a private network on the server 106A. The communication protocol used with the user applet module 402 may be a standard protocol or a custom protocol. This software module implements the server side of the communication protocols and message formats.

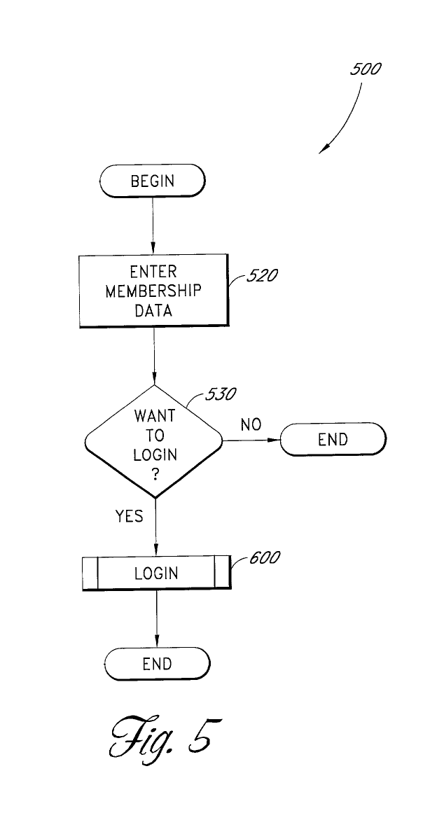

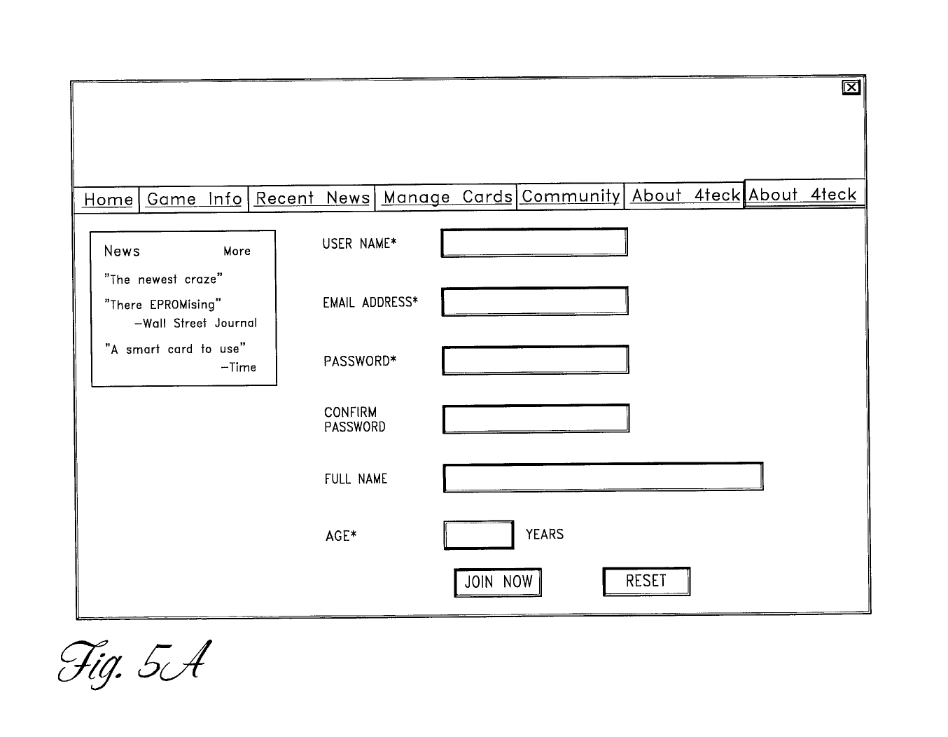

FIG. 5 illustrates the flow diagram of the user option 500 depicted in FIG. 2. This user option allows the user to join an on-line membership thereby having access to various services available to a member. For example, a member can participate in on-line games, manage his/her card collection, register ownership of the smart trading card to facilitate ownership tracking, and to participate in on-line trading.

At a step 520, the user enters membership data to join the on-line membership. The membership data can include, for example, a user name, an email address, a password, full name, and age.

FIG. 5A illustrates an example user interface screen to facilitate entering of the membership data. As illustrated in FIG. 5A, membership data entered by the user may include a user name, an email address, a password, a confirming password, and age, for example. The user name may be used to better personalize the web site for the user while the email address may be used to exchange relevant communication with the user. The password and the confirmation of password, as well as the user's full name may be used to facilitate maintaining security for the user's account. The age of the user may be used to comply with various laws mandating restriction of certain information to and from a minor.

After joining the membership, at a decision step 530, the user may choose to login to a main server application to obtain access to various services available to members. If the user chooses to login, the control flows to the user option 600 to initiate the login process. Otherwise, the user option 500 ends.

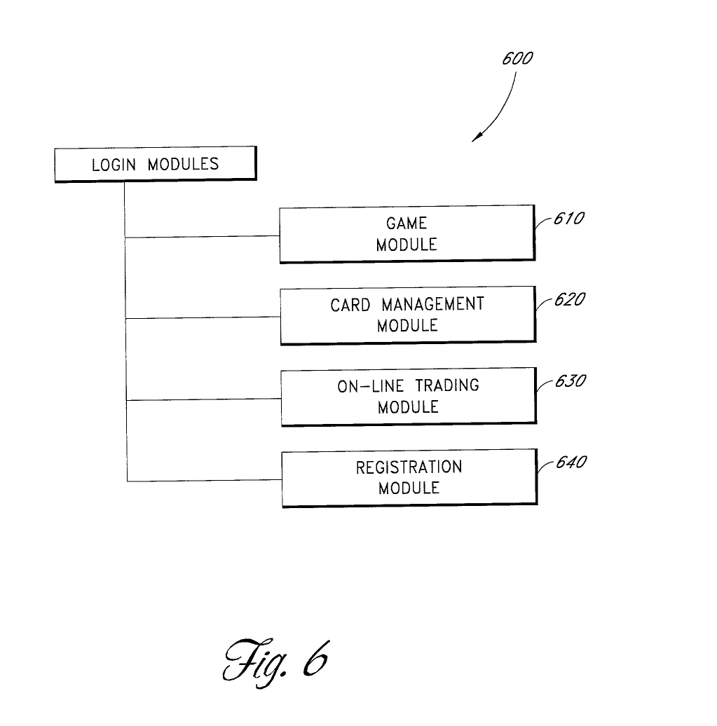

FIG. 6 is a block diagram illustrating various modules of user option 600. As illustrated in FIG. 6, the login option 600 comprises a game module 610, a card management module 620, an on-line trading module 630, and a registration module 640.

The game module 610 allows the user to select and play an on-line game. The card management module 620 provides various options related to management of the cards such as adding the card into the master catalog, specifying viewing preferences, customizing the user's collection, and viewing ownership history. The on-line trading module 630 provides the ability to engage in on-line trading sessions with other users. The registration module 640 handles card registration.

The modules and methods illustrated in the figures can be interrelated such that various functionalities enabled by any of the modules or methods can be invoked from any other module. Moreover, as indicated previously, it is contemplated that the system and method disclosed herein may be implemented using any digitally embedded items. For example, the verification of authenticity of a collectible doll embedded with digital data may be accomplished by the system and method disclosed herein.

Although the invention has been described in terms of certain preferred embodiments, other embodiments that will be apparent to those of ordinary skill in the art, including embodiments which do not provide all of the features and advantages set forth herein, are also within the scope of this invention. Accordingly, the scope of the invention is defined by the claims that follow. In the claims, a portion shall include greater than none and up to the whole of a thing; encryption of a thing shall include encryption of a portion of the thing. In method claims, reference characters are used for convenience of description only, and do not indicate a particular order for performing a method.

What is claimed is:

1. A method for (a) enhancing the value of collectible trading card by protecting its authenticity, (b) enhancing the collectible trading card ownership experience by enabling the tracking of the identity of previous owners of the collectible trading card, the method comprising:
storing digital authentication data on the collectible trading card;
storing digital validation data for validating the authenticity of the collectible trading card at a networked server physically remote from said collectible trading card;
receiving at said networked server changes in ownership of said collectible trading card;
storing said ownership history at said networked server;
receiving remote requests to verify the authenticity of said collectible trading card; and
comparing the digital authenticity data received from said remote requests with the stored digital validation data.

2. A method for (a) enhancing the value of collectible trading card by protecting its authenticity, (b) enhancing the collectible trading card ownership experience by enabling the tracking of the identity of previous owners of the collectible trading card, the method comprising:
storing digital authentication data on the collectible trading card;
storing digital validation data for validating the authenticity of the collectible trading card;
receiving changes in ownership of said collectible trading card;
storing said ownership history;
receiving remote requests to verify the authenticity of said collectible trading card; and
comparing the digital authenticity data received from said remote requests with the stored digital validation data.

3. A method for (a) enhancing the value of collectible item by protecting its authenticity, (b) enhancing the collectible item ownership experience by enabling the tracking of the identity of previous owners of the collectible item, the method comprising:
storing digital authentication data on the collectible item;
storing digital validation data for validating the authenticity of the collectible item at a networked server physically remote from said collectible item;
receiving at said networked server changes in ownership of said collectible item;
storing said ownership history at said networked server;
receiving remote requests to verify the authenticity of said collectible item; and
comparing the digital authenticity data received from said remote requests with the stored digital validation data.

4. A method for verifying the authenticity of an item containing digitally embedded data over a global network, the method comprising:
storing authentication data on the item;
storing validity data on a networked server;
comparing the authentication data with the validity data;
generating identical blocks of random data;
encrypting first block of random data using the validity data;
encrypting the second block of random data using the authentication data;
comparing the two encrypted block of data.

5. The method as defined in claim 1, further comprising registering the item with the networked server to enable on-line trading of the item.

6. The method as defined in claim 5, further comprising maintaining ownership history of the registered item.

7. The method as defined in claim 5, further comprising playing on-line games after verifying the authenticity of the item.

8. A system of verifying the authenticity of an item embedded with authentication data, the system comprising:
a reader capable of reading the embedded authentication data;
a user processor; and
a server processor
wherein the authenticity of the item is verified using the authentication data, validity data stored on the server processor, randomly generated data blocks, and encrypted versions of the randomly generated data blocks.

9. A system as defined in claim 8, wherein the item is a smart card with embedded memory device.

10. A system as defined in claim 8, wherein ownership history of the item is maintained.

11. A system as defined in claim 8, wherein the item is traded on-line after verifying the item's authenticity.
